(19) United States
(12) Patent Application Publication
(10) Pub. No.: US 2006/0058713 A1
(43) Pub. Date: Mar. 16, 2006

(54) Massage cushion

(76) Inventor: Dong-Hee Lee, Seoul (KR)

Correspondence Address: DLA PIPER RUDNICK GRAY CARY US LLP, P. O. BOX 9271, RESTON, VA, 20195, US

(21) Appl. No.: 10/514,837

(22) PCT Filed: May 2, 2003
(86) PCT No.: PCT/KR03/00887

§ 371 Date: Nov. 18, 2004

(30) Foreign Application Priority Data
May 20, 2002 (KR) 20-2202-0015354
Nov. 20, 2002 (KR) 10-2002-0072394

(51) Int. Cl. A61H 1/00

(52) U.S. Cl. 601/57; 601/56; 601/49; 601/46; 601/78

(57) ABSTRACT

The present invention relates to a massage cushion, and in particular to an improved massage cushion which is capable of implementing a massage based on a certain elastic force with respect to a tight contact portion in such a manner that a vibrator installed in an elastic member in the interior of a cushion body upwardly and downwardly moves a massage member based on a certain lithium by a controller when an operation is performed using a button in a state that a massage cushion is tightly contacted with a user's waist, back, neck, etc.

### BACKGROUND OF THE INVENTION

1. Field of the Invention

The present invention relates to a massage cushion, and in particular to an improved massage cushion which is capable of implementing an improved massage based on a certain elastic force with respect to a tight contact portion in such a manner that a vibrator installed in an elastic member in the interior of a cushion body upwardly and downwardly moves a massage member based on a certain rhythm by a controller when an operation is performed using a button in a state that a massage cushion is tightly contacted with a user's waist, back, neck, etc.

2. Description of Related Art

Generally, in a massage machine, a plurality of vibrators are provided in a chair, so that the vibrators are operated based on a switching operation, so that a user is effectively massaged.

Recently, a pillow with a vibration function is disclosed. In the above pillow, an eccentric weight installed in the pillow is rotated for thereby generating a vibration torque, so that a user's fatigue is relieved based on a vibration operation.

In addition, the above vibration force is adapted to a head rest of a vehicle for thereby supporting a driver's neck, etc, so that it is possible to relieve a driver's fatigue.

However, the above conventional massage is directed to relieving a user's fatigue based on only a trembling vibration, so that it is impossible to effectively implement a desired massage effect such as a pat massage.

### SUMMARY OF THE INVENTION

Accordingly, it is an object of the present invention to provide a massage cushion which overcomes the problems encountered in the conventional art.

It is another object of the present invention to provide a massage cushion which is capable of pat-massaging a user's waist, back, net, etc, in such a manner that vibrators upwardly and downwardly move a massage member using an elastic force of an elastic member by providing a plurality of vibrators in a cushion adapted to make a user's waist be comfortable by supporting a back portion of a user's waist or by supporting the same to a back member of a chair, including a pillow which is generally used at home.

To achieve the above objects, there is provided a massage cushion which includes a cushion body which is formed of a buffering material and has at least two grooves opened in one side tight contact surface, an elastic member which is engage-provided in the cushion body and is positioned in an entrance portion of each groove, a plurality of vibrators which are inserted into the grooves and connected with the elastic member and adapted to move the massage member upwardly and downwardly, and a controller which is provided in the cushion body and controls the vibrators in accordance with an operation of a button which is exposed from the cushion body.

In the present invention, the cushion body and vibrators are surrounded by an outer skin layer.

In addition, a wing member is provided in one side of the outer skin layer, and a button is provided in the wing member for starting an operation of the massage cushion.

The tight contact surfaces of the elastic member and cushion body are tightly contacted with a certain body portion of a user such as a user's waist, neck. Etc.

The vibrator includes a bobbin in the casing, a lifting and lowering shaft which is moved upwardly and downwardly by a magnetic force of the bobbin, and a massage member provided in an upper portion of the lifting and lowering shaft.

### BRIEF DESCRIPTION OF THE DRAWINGS

The present invention will become better understood with reference to the accompanying drawings which are given only by way of illustration and thus are not limitative of the present invention, wherein;

FIG. 1 is a side cross sectional view illustrating a massage cushion according to the present invention;

FIG. 2 is a front view of FIG. 2; and

FIG. 3 is a cross sectional view taken along line C-C of FIG. 1 for explaining a state of use according to the present invention.

### DETAILED DESCRIPTION OF PREFFERED EMBODIMENTS

The massage cushion according to the present invention will be described in detail with reference to the accompanying drawings.

In the present invention, there are provided a cushion body 100 formed of a buffering material, an elastic member 200 having a certain elastic force, and vibrators 300 which are installed in the cushion body 100 for thereby performing a massaging operation based on an elastic force of the elastic member 200.

The cushion body 100 is formed of a buffering material. A circular shaped tight contacting groove 120 is formed in one side tight contact surface of the same in such a manner that a user's waist, back, neck, etc. is surrounded tightly. At least two opened grooves 110 are formed in the tight contact groove 120.

The buffering material may be formed in a sponge shape and may be provided in multiple numbers in an integral shape or plate shape. In addition, the buffering material may be formed of a buffering type shape memorizing material which is recently available.

The elastic member 200 is provided in pair in a band shape having a lo certain elastic force. Both ends of the elastic member 200 are tightly contacted along the tight contact grooves 120 of the cushion body 100 and are engaged in the cushion body 100 and is provided to sufficiently cover the entrance of the groove 110 formed in the tight contact groove 120 in such a manner that the entrance portion of the groove 110 formed in the tight contact groove 120 is exposed to the outside by a certain width.

Here, the elastic member 200 preferably covers the entire portions of the entrance portion of the groove 110.

The vibrators 300 each are inserted into the grooves 110 and are connected with the elastic member 200 for thereby vibrating the exposed massage members 310 when a power is applied.

In other words, the vibrators 300 each include a casing 320 which is formed in the same shape as the vibrator used in a well known vibrator, a bobbin 330, a lifting and lowering shaft 340, and a massage member 310.

The casing 320 accommodates the bobbin 330 and includes a bracket bent to be fixed between the elastic members 200 in a bent outer upper portion.

The bobbin 330 is adapted to upwardly and downwardly move the lifting and lowering shaft 340 inserted into a center vertical groove based on a magnetic variation when a power is applied.

The lifting and lowering shaft 340 includes a massage member 310 in the upper portion of the same for thereby patting a certain body potion when the same is upwardly and downwardly moved.

The controller 400 is installed in the cushion body 100 and turns on and off the vibrators 300 based on a button operation.

In addition, an outer skin layer 130 surround the outer surface of the cushion body 100. The outer skin layer 130 also surrounds the massage member 310 of the vibrator 300.

A certain size wing member 140 is formed in one side of the outer skin layer 130, and a button 410 is provided in the wing member 140 for thereby outputting a certain signal value to the controller 400.

The assembling and usage of the thusly constituted massage cushion will be described with reference to the accompanying drawings.

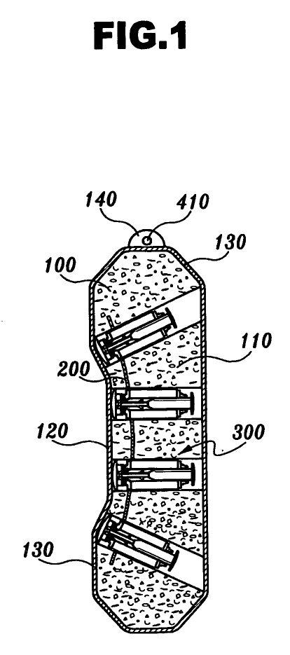

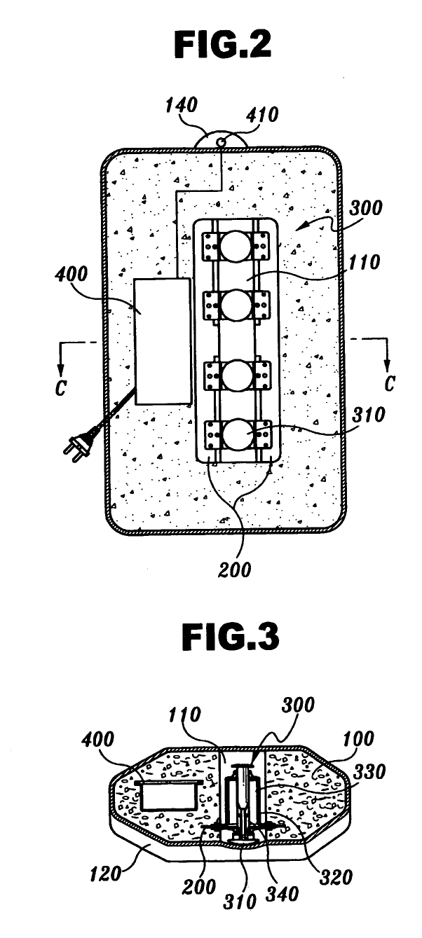

When fabricating and assembling the massage cushion according to the present invention, as shown in FIGS. 1 through 3, a circular tight contact portion is formed in the cushion body 100 formed in a buffering material. A plurality of the upwardly opened grooves 110 are formed in the above tight contact surface. The elastic members 200 are fixedly provided in the cushion body 100 in such a manner that the elastic members are positioned in the entrance portions of the grooves 110 in a pair shape in left and right portions. The outer brackets of the casing 320 of the vibrator 300 inserted in the grooves 110 are fixedly connected between the elastic members 200, and the controller 400 is installed in the interior of the cushion body 100, and the outer skin layer 130 covers the above elements for thereby fabricating the massage cushion according to the present invention.

When using the massage cushion according to the present invention, the circular tight contact grooves 120 are tightly contacted with a user's waist, back, neck, etc., and the button 410 provided in the wing member 140 of the outer skin layer 130 is pressed. The vibrators 300 are operated based on the turn on operation of the button 410, and the massage members 310 of vibrators 300 are moved upwardly and downwardly for thereby pat-massaging the user's tightly contacted body portions.

Therefore, in the massage cushion according to the present invention, it is possible to easily perform a massage at any place by providing a plurality of vibrators which perform a massage operation when the massage members are moved upwardly and downwardly, in a cushion supported by the user's waist or back and supported by the back portion of a chair.

In addition, the cushion body and elastic member formed of the buffering material are tightly contacted with the massage members of the vibrators in a certain body portion such as leg calf, waist, neck, thigh, abdomen, shoulder, etc. which needs a certain massage as the cushion and elastic members formed of the buffering material are flexible, so that it is possible to implement an effective massage operation.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A massage cushion comprising:
a cushion body which is formed of a buffering material and has at least two grooves opened in one side tight contact surface;
an elastic member which is engage-provided in the cushion body and is positioned in an entrance portion of each groove;
a plurality of vibrators which are inserted into the grooves and connected with the elastic member and adapted to move the massage member upwardly and downwardly; and
a controller which is provided in the cushion body and controls the vibrators in accordance with an operation of a button which is exposed from the cushion body.

2. The cushion of claim 1, wherein said cushion body and vibrators an surrounded by an outer skin layer.

3. The cushion of claim 1, wherein a wing member is provided in one side of the outer skin layer, and a button is provided in the wing member for starting the operation of the cushion.

4. The outer cushion of claim 1, wherein the tight contact surfaces of the elastic member and cushion body are tightly contacted with a certain body portion of a user such as a user's waist, neck, etc.

5. The cushion of claim 1, wherein said vibrator includes a bobbin in the casing, a lifting and lowering shaft which is moved upwardly and downwardly by a magnetic force of the bobbin, and a massage member provided in an upper portion of the lifting and lowering shaft.

6. The cushion of claim 2, wherein a wing member is provided in one side of the outer skin layer, and a button is provided in the wing member for starting the operation of the cushion.
